(19) United States
(12) Patent Application Publication
(10) Pub. No.: US 2016/0058635 A1
(43) Pub. Date: Mar. 3, 2016

(54) MOBILITY DEVICE

(71) Applicants: Gerry MURPHY, Ballina (IE); Edward MURPHY, Ballina (IE)

(72) Inventors: Gerry MURPHY, Ballina (IE); Edward MURPHY, Ballina (IE)

(21) Appl. No.: 14/476,374

(22) Filed: Sep. 3, 2014

(51) Int. Cl. A61G 3/00; B61B 13/08

(52) U.S. Cl. CPC A61G 3/00; B61B 13/08

(57) ABSTRACT

A device for moving a person with reduced mobility about an area to be traversed is described and comprises: a base for supporting the weight of the person to be moved; a vertical support extending upwards from the base for supporting the upper body weight of the person to be moved; at least one guide means provided along a predetermined route about the area to be traversed, wherein the base is moveable along the route determined by the guide means; wherein movement of the base along the guides means moves the person from a first location to a subsequent location.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The invention relates to devices for improving mobility of aged, ill or disabled users. In particular, the invention relates to devices for improving mobility about a living area or other desired space. The invention also relates to devices for providing support for people with partially paralyzed lower limbs or missing lower limbs but who still have some upper body strength.

### BACKGROUND OF THE INVENTION

Ageing, disability or illness can lead to weakened limbs, backs and/or muscles, and if severe enough, can make it difficult for a person to stand up or sit down unaided. In severely affected people, walking may be painful, difficult or indeed impossible. It is a fact of life that people can require help in moving from one position to another.

Wheelchairs are commonly used for relocating persons with poor or reduced mobility. However, the problem remains of moving or transferring such persons from a bed or chair to a wheelchair so that they can be moved around a living area or over a distance. If the person is particular weak or disabled, then they are unlikely to be able to transfer themselves from a resting location to a wheelchair. This may be particularly the case if the person is large in size. In these instances, more than one person may be needed to assist in moving the person to a wheelchair. In some cases, a hoist may be needed, so that the risk that manual lifting and handling will strain or injure the person assisting is reduced insofar as possible.

There are different types of hoists depending on a person's particular requirements. Standard mobile hoists, toileting/standing hoists, and mobile seat hoists are all popular and it is often the case that more than one type of hoist may be required for the same person, depending on their abilities and/or specific needs. Mobile hoists typically have a mobile base and a sling lifting mechanism and are used by a carrier to lift and transfer a person from one surface to another. Typically, these types of lifting aids are designed to move on two to four castor wheels, with the aid of carriers being required. Some drawbacks are that hoists cannot be used by the person independently and the person has to be lifted in a sling. In general, use of hoists is considered laborious and they generally take a good deal of time to operate.

Independent use is only possible using an overhead hoist (mobile hoists generally require at least one assisting person.) Where hoists are used, quite an amount of space is often required to manoeuvre the hoist and the person into the desired position. This means that furniture may have to be moved or removed to accommodate the equipment. Also a hoist may not be suitable for use in rooms having carpets or rugs etc., as these materials may impede movement. Furthermore, the size and strength of the carrier must be considered, as it requires quite a lot of effort to turn and move a mobile hoist.

It is an object of the invention to provide equipment to facilitate greater independence and mobility of an aged, ill or disabled person. It is an object of the invention to provide such equipment can be used independently by the user, and that is relatively inexpensive and easy to install and operate. It is a further object of the invention to provide equipment that provides for selection of at least one predetermined route for the person to traverse in a desired space or area. It is a further object of the invention to provide means for allowing a user to improve circulation and provide means for strengthening a user's upper body. It is a further object of the invention to provide such equipment that can reduce risk of sustaining injury and improve the quality of life an aged, ill or disabled person.

### SUMMARY OF THE INVENTION

According to the present invention, as set out in the appended claims, there is provided a device for moving a person with reduced mobility about an area to be traversed comprising:

a base for supporting the weight of the person to be moved;

a vertical support extending upwards from the base for supporting the upper body weight of the person to be moved;

at least one guide means provided along a predetermined route about the area to be traversed, wherein the base is moveable along the route determined by the guide means;

wherein movement of the base along the guide means moves the person from a first location to a subsequent location.

Advantageously, the device of the invention solves of the problem of how to move a person with reduced mobility around a room, living space or other desired area without need for use of hoists, or if the user so desires, with need for the presence of at least one assistant or carrier to aid with operating a hoist or other movement means. The device is suitable for use in a room in a house or hospital or the like or any other space or area where it is desired for the user to traverse.

In a preferred embodiment, the movement of the base along the guide means can be carried out by the person to be moved themselves (the primary user or “user” as designated hereinafter). For example, the device may be motorized and operable by electricity from grid power supply or battery. However, if as assistant or carrier is present, this person may simply move the base along the guide means to any desired point.

In a preferred embodiment, the vertical support may comprise hinge means for pivoting an upper part of the support toward and away from the person to be moved depending on whether the user is mounting or dismounting the device. The degree of pivot may be adjusted depending on the height from which the user is being moved. For example, the seat of a chair might be lower than the surface of a bed or toilet seat.

Suitably, the device may further comprise at least one handle means attached to the vertical support. Handle means facilitate the user pulling themselves onto the device for movement, and for supporting them in an upright position when they are located thereon. Preferably, the handle means takes the form of a frame onto which an object support, such as a small table or cup rest, etc., may be optionally mounted. A frame type handle means is desirable since it allows the user to slouch over the frame to rest if necessary, for example, if the user is standing for an extended period. The skilled person will appreciate that certain benefits to standing upright arise using the device of the invention and include, weight bearing on feet, legs and pelvis, improved circulation which can assist in reducing oedema or swelling in the limbs. A frame also provides more gripping area for the user allowing the user great freedom in manipulating the lower body onto and off of the base of the device, when no assistant or carrier is present. The frame may be substantially circular or oval shaped, square shaped rectangular or triangular shaped, etc.

Advantageously, the device of the invention may further comprise at least one of: a shin, knee or thigh support block mounted onto the vertical support. Such support blocks facilitate the user standing safely, securely and comfortably on the device, since the support can assist maintaining the limbs in a desired position. Straps, ties or Velcro or other securing means can be included on the device if further support and/or security are required.

The base, frame, shin, knee or thigh support blocks may be covered in foam or soft fabric or material which will assist in reducing blister or calluses that may occur or other material that may be specifically chosen to assist in maintaining good grip. For example, a non-slip material or fabric may be used.

Preferably at least one guide means form the predetermined route. Suitably, at least two guide means may be positioned side by side along the predetermined route. Preferably a pair of guide means may be provided. Suitably, the guide means may be provided in a substantially liner, circular, square, rectangular or any desired branched or crossing arrangement (route), depending on the size of the area to be traversed and requirements of the user and the nature of the furnishings/objects in the area. Directing means can be provided on the guide means where branching or crossing arrangement is desired for diverting the direction of travel of the device from one route to a further route. In such an embodiment, and where the device is electrically operated, it is preferred that a controller is provided on the device to allow the user to input directional instruction and speed for example into the controller to give specific instructions for operation.

In a further preferred embodiment of the device of the invention, the guide means may comprises at least one slide mechanism. Suitably, the slide mechanism may be a rail or track means for dictating the travel direction of the device. Suitably, the base of the device may be adapted to engage with guide means. For example, at least one runner, castor, wheel or cog or the like may be provided on the base, and may be adapted, dimensioned or configured to be securely accommodated within or along the guide means for movement of the based there along. Preferably, the base is adapted to comprise at least one runner which is adapted to slide within a groove provided in a rail, thereby forming one preferable example of a guide means. Suitably the runner is adapted to be provided with tongues or protrusions that are dimensioned to lock within such a groove on the rail, to allow secure sliding movement of the base along the rail.

In a preferred embodiment, the guide means may be provided in or above a floor or surface of the area to be traversed or the guide means may be provided in or above a platform suitable for laying on a floor or surface of the area to be traversed. This means that the guide means can be incorporated into or on top of the floor or surface of the area when constructed, or can be provided in its own right as a platform forming part of the device onto which or in which the guide means may be provided, depending on the requirement of the user and their budget.

Preferably, the vertical support of the device of the invention, the base, and platform may be made from a metal, metal alloy, wood or plastic. For example, preferably at least one of these components may steel. In a preferred embodiment, the base and/or platform may be made of metal, wood or plastic. For example, steel is preferred. Suitably, the guide means may be made from at least one of metal, wood or plastic.

In a particularly prefer embodiment of the device of the invention, the base may be adapted for rotation about an axis perpendicular to the base. Preferably, the base may rotate (about a particular point along the route set by the guide means) at a rotation angle of up to 360°, or multiples of same. This is advantageous as the unlimited rotation means the positioning options for user (relative to objects positioned nearby) are maximized. If it is so desired, the base can be set to rotate to a more limited angular range. In a preferred embodiment, the base can be rotatably mounted on a rotation support, onto which the base may be mounted. Suitably, the rotation support may be moveable mounted onto the guide means. Suitably, the rotation support may be directed mounted on the guide means for movement there along (but not for rotation movement about a vertical axis lying perpendicular to the rotation support. Suitably the base (for supporting the user's weight) may be mounted over the rotation support in such a way so that the base is rotatable about the rotation support part of the device.

In a preferred embodiment, the rotation support may be provide with a vertical column (known hereinafter as the inner vertical column) which projects upwards from the plane of the rotation support. The inner vertical column is preferably dimensioned to be accommodatable within a hollow provided within the vertical support that projects from the base part of the device. The base and the hollow vertical support attached thereto, and which projects from the base, can be fitted on top/over the rotation support and the inner vertical column attached to the rotation support. Preferably, at least one rotation bearing means are provided within the hollow of the vertical support and are suitably dimensioned to receive the inner vertical column. When configured together, the combination of the inner vertical column of the vertical support lying within the hollow vertical support of the base, coupled together by at least one rotation bearing means, allows the vertical support and base to rotate about the inner vertical support and rotation support. Since the inner vertical column is fixed to the rotationally stationary rotation support, the rotation bearings allow the base and vertical support to rotate 360° about the vertical axis provided by the inner vertical column. This mechanism allows the user to rotate the base around to any desired angle.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 shows a top perspective view of a schematic drawing of one example of the device of the invention on which the device is provided on a platform;

FIG. 2 shows a top plan view of a schematic drawing of one example of the device of the intention where the options for rotation of the base about a vertical axis perpendicular to the base are indicated by the directional arrows shown;

FIG. 3 shows an a top perspective view of a schematic drawing of one example of the device of the invention without the platform;

FIG. 4 shows an a top perspective view of a rendered schematic drawing of one example of the device of the invention on which the device is provided on a platform and the user is about to dismount the device onto a bed;

FIG. 5 shows an a top perspective view of a rendered schematic drawing of one example of the device of the invention on which the device is provided on a platform and the user is about to dismount the device onto a chair;

FIG. 6 shows a close up view of one example of the guide means provided on the device of the invention;

FIG. 7 shows the underside of the rotation support portion of the device;

FIG. 8 shows a schematic drawing of one example of the base rotation means of the device of the invention;

FIG. 9 shows a sketch of a further example of the base rotation means of the device of the invention; and

FIG. 10 shows a sketch of a further example of the base rotation means of the device of the invention.

### DETAILED DESCRIPTION OF THE INVENTION

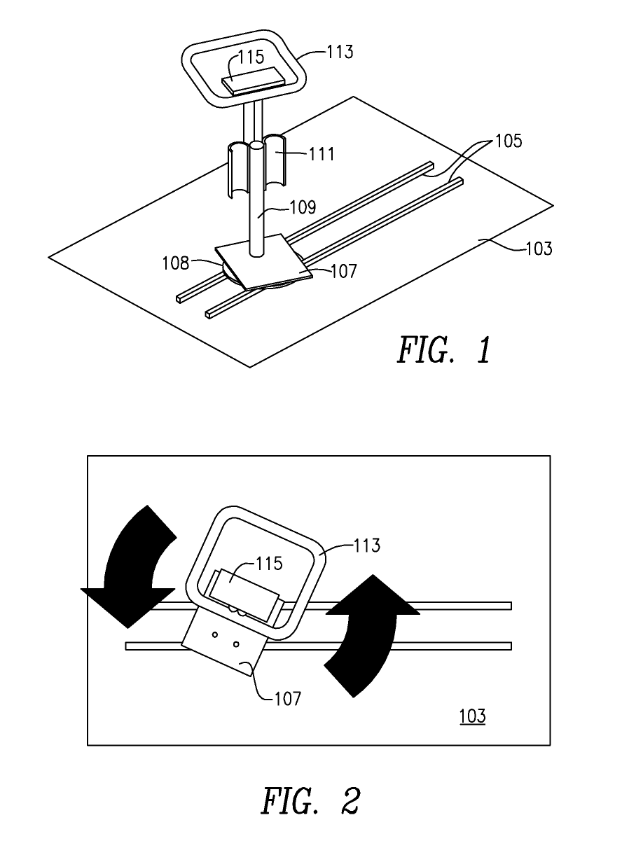

Referring now to the drawings and specifically FIGS. 1 to 10 inclusive and initially FIG. 1. FIG. 1 shows an example of a preferred device (101) of the invention. In this embodiment, a platform (103) is provided onto which a pair of parallel rails (105) are mounted. Alternatively, the rails can be provided within a space provided in the platform (see FIGS. 8-10). Base (107), onto which the user support their weight, is moveable mounted onto the platform (103) for movement along the rails (105) and for rotational movement about vertical axis defined by a vertical column (109) which extends or projects from the base (107). The base (107) is mounted on a further rotational support (108) which is adapted to allow the rotation of base (107) about said vertical axis. The vertical column (109) and have a pair of knee blocks (111) attached thereto for supporting the user's legs. Square frame (113) is provided at the top of vertical column (109). An object rest is also visible in its position mounted onto the frame (115). In embodiments having a controller (not shown), the controller can be provided in this same position.

FIG. 2 shows the direction of rotation of the base (107) about the vertical axis perpendicular to the base (107). The direction of rotation is indicated by the arrows.

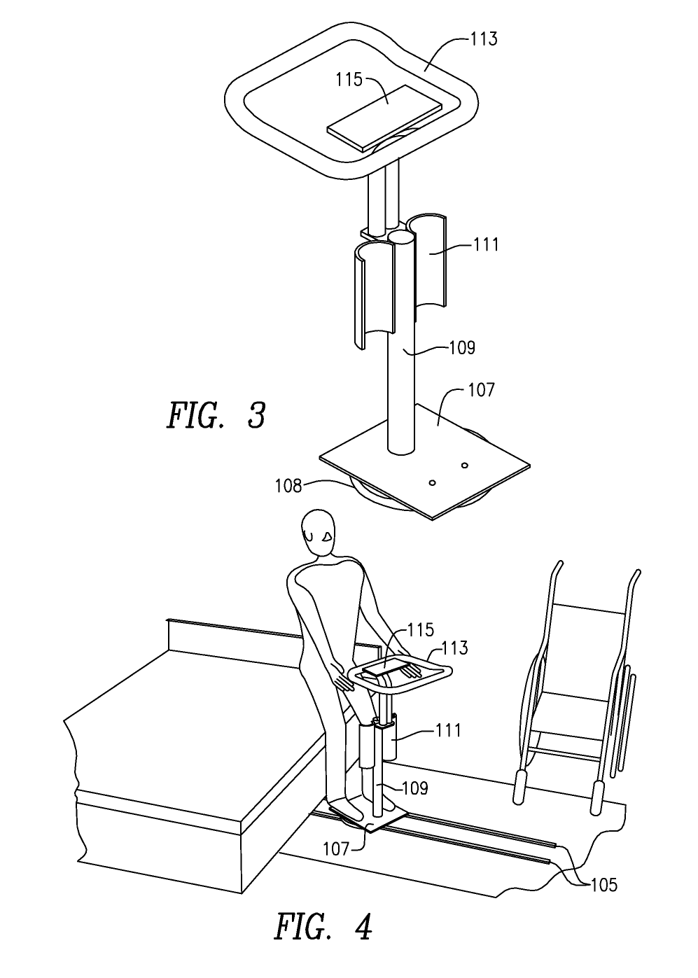

FIG. 3 shows the device (101) removed from the platform (103). In this drawing, the rotational support (108) which is adapted to allow for rotation can be observed.

FIG. 4 shows the user (119) about to dismount the device (101) onto a bed (121). A wheelchair and bed are also shown in this drawing.

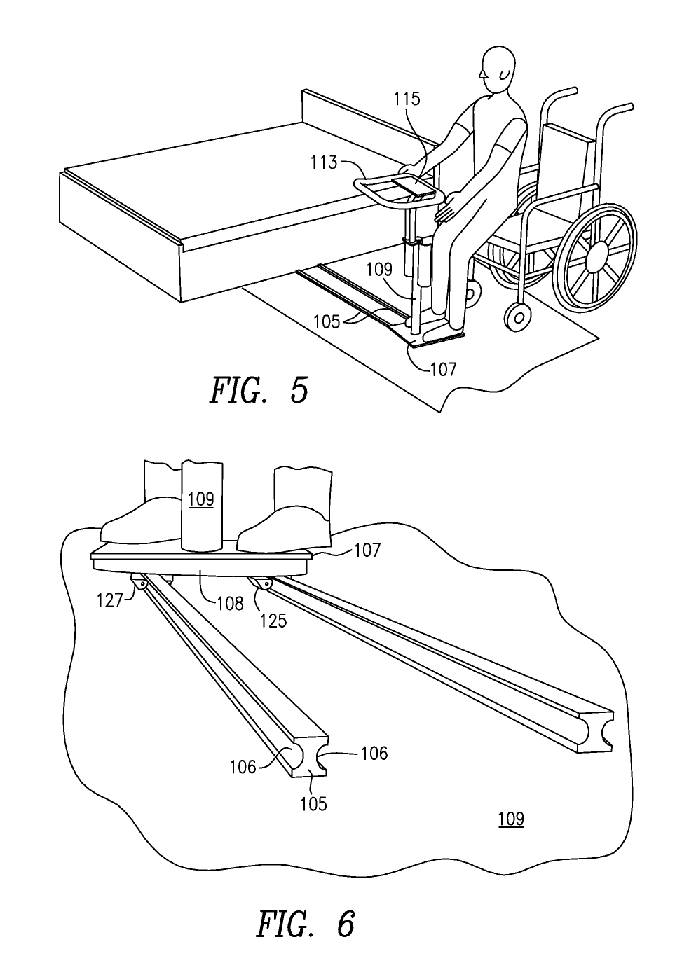

FIG. 5 shows the user about to dismount the device (101) onto the wheelchair.

FIG. 6 shows a close up of how the base (107) mounted on the rotation support (108) moves along the parallel rails (105). Grooves (106) are provided on both opposing sides of the rails (105). Tongues (125) provided on linear runners (127) which are in turn provided on the underside of rotation support (108) for securely engagement in the grooves (106) of the rails (105) by sitting into the grooves (107) thereby locking the base (107) to the rails (105) thereby forming the sliding arrangement, in such as way as to allow movement in one direction (along length of rails (105)).

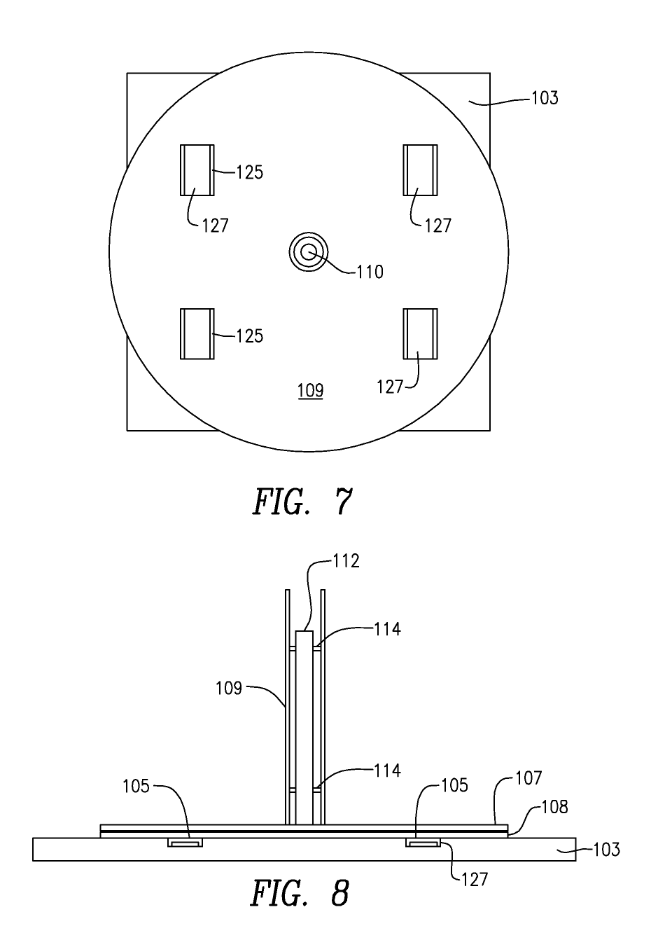

FIG. 7 shows the underside of rotation support (108) and typical positioning of linear runners (127). The tongues (125) of the linear runners (127) are shown in broken lines in this drawing. Also shown in the attachment (110) of the vertical column (109) and inner vertical column (112) (not shown in this drawing) to the rotation base (108).

FIG. 8 shows a schematic drawing of one arrangement of the invention wherein the rails (105) are provided within the body of the platform (103). The runners (127) are located on the underside of rotation support (108) and are dimensioned to sit flush with the surface of the platform (103) in this particular embodiment. Inner vertical column (112) can be seen extending upright from the rotation support (108). The base (107) and vertical column (109) for supporting the user is rotatably mounted on top of the rotation support (108) and inner vertical column (112), so that the inner vertical column (112) sits within the vertical column (109). This arrangement is secured by a pair of rotation bearings (114), which rotatably couple the vertical column (109) and base (107) to the inner vertical column (112) and rotation support (108) for 360° rotation thereon.

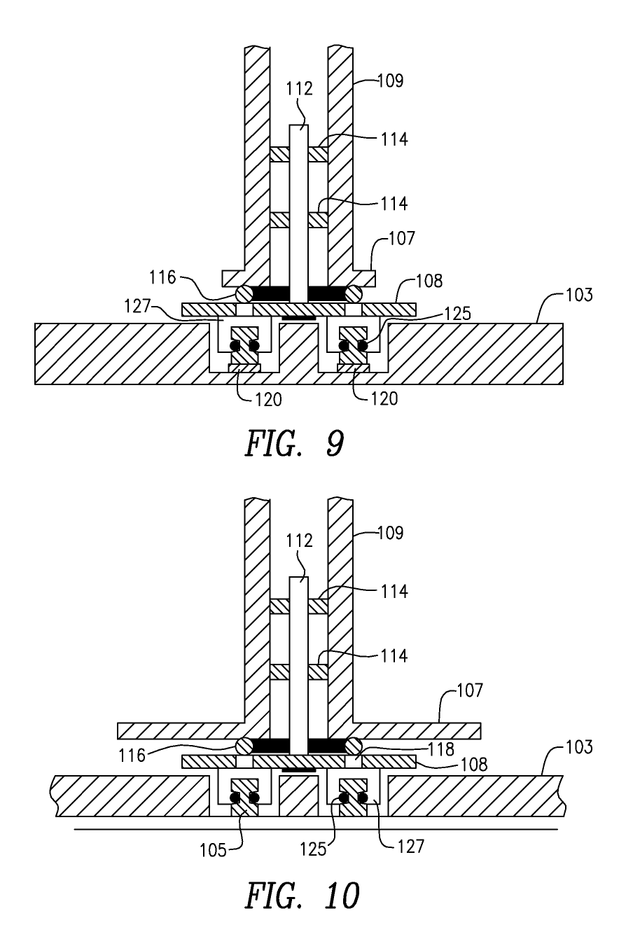

FIG. 9 shows another example of the rotation arrangement, where a rotation ring (116) is provided between the base (107) and the rotation support (108). Circular groove (118) is provided in rotation support (108). The rotation ring (116) may be fixed attached to the rotation support (108) or to the underside of base (107) to facilitate rotation thereon. If necessary height adjustment blocks (120) can be provided underneath the rails (105) to adjust the rail height and height of rotation support (108) off the platform.

FIG. 10 shows a similar arrangement to that of FIG. 9, but the base (107) projects beyond that of the rotation support (108).

In operation, on wishing to move position, the user simply moves the device (101) into an aligned position in front of them. The user may then rotate or swivel the device (101) around its base (107), so that the device (101) is orientated correctly in the mount position. This is the position in which the knee blocks (111) are in the correct orientation to act as supports for the user's legs. When the device (101) is correctly aligned with the user, the user can reach towards to the handle (113) on the top of the device (101) and when a sufficient engagement is made, the user can pull themselves up towards the device (101) using their upper body strength. The user can grasp the handle (113) on the upper portion of the device (101) for support and to maintain their upright position. The user can then hold the handle (113) with one hand to support and steady themselves, while with the other hand they can to shift their feet and lower body weight onto the base (107) of the device (101). Feet, knees and thighs can be arranged to rest in position using the support blocks (111) provided on the vertical support of the device (101).

When the user is comfortably positioned in an upright and supported position, the base (107), in its position mounted on top of rotation support (108) can be guided (mechanically or electrically or by hand if an assistant is available) along the pre-determined route set out by the rails (105) along the area to be traversed. The movement is facilitated by sliding the base (107) along the route provided by the captive rails (105), which in this embodiment, are fixed to a platform (103), which rests on the floor/ground of the user's bedroom other living space. When the base (107) has reached the desired position, the base (107) may be rotated up to 360° about a vertical axis perpendicular to the plane of the rotation support (108), which stays stationary on the rails (105) in this instance, thereby allowing the user to correctly position themselves to safely dismount from the device (101), for example, onto a chair or a bed or bidet.

Beds, wheelchairs or bidets etc., can be positioned along the line of the rails (105) so that the user or user's assistant can transfer themselves to the various apparatus using device (101) of the invention without requiring hoists or lifting equipment.

The words “comprises/comprising” and the words “having/including” when used herein with reference to the present invention are used to specify the presence of stated features, integers, steps or components but does not preclude the presence or addition of one or more other features, integers, steps, components or groups thereof. It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination. The invention is not limited to the embodiments hereinbefore described but may be varied in both construction and detail.

What is claimed is:

1. A device for moving a person with reduced mobility about an area to be traversed, the device comprising:
a base for supporting the weight of the person to be moved;
a vertical support extending upwards from the base for supporting the upper body weight of the person to be moved;
at least one guide means provided along a predetermined route about the area to be traversed, wherein the base is moveable along the route determined by the guide means,
movement of the base along the guides means moving the person from a first location to a subsequent location.

2. The device of claim 1 wherein the vertical support includes hinge means for pivoting an upper part of the support toward and away from the person to be moved.

3. The device of claim 1, further comprising at least one handle means attached onto the vertical support.

4. The device of claim 3 wherein the handle means is a frame onto which an object support may be optionally mounted.

5. The device of claim 2, further comprising at least one of a shin block, a knee block, or a thigh block mounted onto the vertical support.

6. The device of claim 1, wherein the base is adapted for rotation about an axis perpendicular to the base, wherein the adaptation means the base can be rotatably mounted on a rotation support.

7. The device of claim 1, wherein at least two guide means are provided.

8. The device of claim 7, wherein the guide means are provided in a route that is one of substantially circular, oval, square shaped, in a crossing guide means rout, and in a branching guide means route.

9. The device of claim 1, wherein the guide means comprises at least one slide mechanism.

10. The device of claim 7, wherein the slide mechanism is one of a rail means and a track means into which one of a castor, a wheel, and a cog provided on the base may be securely accommodated for movement of the based there along.

11. The device of claim 1, wherein the guide means is provided in or above a floor or surface of the area to be traversed or is provided in or above a platform suitable for laying on a floor or surface of the area to be traversed.

12. The device of claim 1, wherein the base, vertical support are made from at least one of a metal, a metal alloy, and a durable plastic, and the guide means is made from at least one of a metal, a metal alloy, and a durable plastic.

13. The device of claim 1, wherein the movement of the base is motorized.

14. The device of claim 1, further comprising a controller for inputting directional and speed instructions to control the movement of the base about the predetermined route.

15. A kit for a device for moving a person about an area to be transversed, the kit comprising:
a base for supporting the weight of the person to be moved;
a vertical support for extending upwards from the base for supporting an upper body weight of the person to be moved; and
at least one guide means to be provided along a predetermined route about the area to be traversed, such that the base is moveable along the route determined by the guide means.

16. The kit of claim 15, wherein the device is for use in movement of a person with reduced mobility.

17. The device of claim 15, further comprising a platform adapted to receive the at least one guide means.

18. The device of claim 15, further comprising instructions for assembly.
